(19) United States
(12) Patent Application Publication
(10) Pub. No.: US 2009/0259746 A1
(43) Pub. Date: Oct. 15, 2009

(54) NETWORK MANAGEMENT APPARATUS, NETWORK MANAGEMENT METHOD, AND MONITORING SYSTEM

(76) Inventor: Takehiko SASAKI, Kanagawa (JP)

Correspondence Address: FROMMER LAWRENCE & HAUG, 745 FIFTH AVENUE- 10TH FL., NEW YORK, NY, 10151, US

(21) Appl. No.: 12/420,858

(22) Filed: Apr. 9, 2009

(30) Foreign Application Priority Data
Apr. 11, 2008 (JP) P2008-103049

(51) Int. Cl. G06F 15/173

(52) U.S. Cl. 709/224

(57) ABSTRACT

A network management apparatus includes: an information acquisition section obtaining path information and link quality information from a plurality of wireless terminals operating in an ad hoc mode; and a display-information generation section generating a network configuration diagram showing a link state between the wireless terminals from the obtained path information, and changing an attribute of a display showing an established link in accordance with the link quality information.

### BACKGROUND OF THE INVENTION

1. Field of the Invention

The present invention relates to a network management apparatus, a network management method, and a monitoring system. More particularly, the present invention relates to a network management apparatus, etc., which obtain path information and link quality information from a plurality of wireless terminals operating in an ad hoc mode, and generates a network configuration diagram on the basis of the obtained path information and link quality information. The network configuration diagram helps a user to easily grasp established links and quality states of the links.

2. Description of the Related Art

To date, network systems have been easily constructed without carrying out wiring work, etc., using terminals having wireless communication functions. In this wireless communication network, an infrastructure mode or an ad hoc mode is used.

In the infrastructure mode, each wireless communication apparatus performs communication using an access point as a relay point. A transmission-source wireless communication apparatus makes a data transmission request to the access point, and if the request is permitted by the access point, the wireless communication apparatus transmits data to the access point. And the access point transfers the data to a transmission-destination wireless communication apparatus. In this manner, in the infrastructure mode, only a wireless communication apparatus having obtained a transmission right can transmit data, and thus the probability of data collision is low. Accordingly, it is possible to construct a network using a large number of wireless communication apparatuses.

Also, in the ad hoc mode, each wireless communication apparatus performs communication without using an access point. Data transmitted from a transmission-source wireless communication apparatus goes through a wireless communication apparatus having a relay function in a transmission range of the transmission-source wireless communication apparatus, and another wireless communication apparatus having a relay function in a transmission range of the wireless communication apparatus having that relay function in sequence. Finally, the data is sent to the destination wireless communication apparatus. Using such an ad hoc mode, it becomes possible to perform communication between desired wireless communication apparatuses without providing an access point unlike the case of the infrastructure mode. However, in the ad hoc mode, data transmission is not centrally controlled as in the case of the infrastructure mode, and thus it is difficult to easily grasp state of a network.

Accordingly, for a wireless communication apparatus in an ad hoc mode, proposals allowing visualization of paths through which data is relayed have been made. For example, in Japanese Unexamined Patent Application Publication No. 2007-104536, in a wireless terminal capable of communication in the ad hoc mode, a radio level with an adjacent node is detected, and a number of adjacent nodes communicable in the ad hoc mode and a radio level are displayed on a display device on the basis of the detection result of the radio level. Also, Japanese Patent No. 3938585 has disclosed a technique in which a wireless terminal is provided with a display section indicating receipt of relay data, for example a light-emitting device, such as an LED, etc., and light is emitted in the case of receiving relay data, thereby allowing easy determination of receipt of relay data. Also, in Japanese Patent No. 3938585, receipt of relay data is informed by sound or by vibration in addition to by light.

### SUMMARY OF THE INVENTION

If a communication state is displayed by each wireless communication apparatus as described in Japanese Unexamined Patent Application Publication No. 2007-104536 and Japanese Patent No. 3938585, in order to manage the entire network, it is necessary to check a communication state of each wireless communication apparatus individually. Thus, it is difficult to perform overall management easily.

It is therefore desirable to provide a network management apparatus, a network management method, and a monitoring system which can easily perform overall network management.

The idea of the present invention is to generate a network configuration diagram on the basis of the information obtained from a plurality of wireless terminals operating in an ad hoc mode, and to enable a user to easily grasp established links and the quality states of the established links by the network configuration diagram.

According to an embodiment of the present invention, there is provided a network management apparatus including: an information acquisition section obtaining path information and link quality information from a plurality of wireless terminals operating in an ad hoc mode; and a display-information generation section generating a network configuration diagram showing a link state between the wireless terminals from the obtained path information, and changing an attribute of a display showing an established link in accordance with the link quality information.

Also, according to another embodiment of the present invention, there is provided a method of managing network, including the steps of: obtaining path information and link quality information from a plurality of wireless terminals operating in an ad hoc mode; and generating a network configuration diagram showing a link state between the wireless terminals from the obtained path information, and changing an attribute of a display showing an established link in accordance with the link quality information.

Further, according to another embodiment of the present invention, there is provided a monitoring system including: an imaging apparatus including a function of wireless communication in an ad hoc mode; and a monitoring apparatus displaying an image on the basis of image data obtained from the imaging apparatus, wherein the monitoring apparatus includes an information acquisition section obtaining path information, link quality information, and captured image information from the imaging apparatus, and a display-information generation section generating a network configuration diagram showing a link state between the wireless terminals from the obtained path information, and changing an attribute of a display indicating an established link in accordance with the link quality information.

In an embodiment of the present invention, path information and link quality information are obtained from a plurality of wireless terminals operating in an ad hoc mode, and a network configuration diagram displaying link states among wireless terminals is generated from the obtained path information. Here, an established link is shown by a line, for example. Alternatively, a path of an established link is shown by an arrow from a transmission-source wireless terminal to a destination wireless terminal. Alternatively, a dummy image simulating a data unit having an established link is disposed among the wireless terminals, and the dummy image is moved from the transmission-source wireless terminal to the destination wireless terminal. In this manner, an established link is shown by a line, an arrow, or a dummy image, etc. Further, the display attributes, for example, a type of line, color of line, a width of line, a number of dummy images, and a speed of the movement are changed in accordance with a link quality, for example, an S/N ratio, a packet (frame) loss rate, and a delay time, and the like. Also, if the user selects a link, information indicating the link quality is displayed.

By the present invention, path information and link quality information are obtained from a plurality of wireless terminals operating in an ad hoc mode, a network configuration diagram displaying link states among wireless terminals is generated from the obtained path information, and a display attribute indicating an established link is changed in accordance with the link quality information. Thus, it is possible to easily manage the network using the generated network configuration diagram.

### BRIEF DESCRIPTION OF THE DRAWINGS

FIG. 1 is a diagram illustrating a configuration of a network system;

FIG. 2 is a diagram illustrating a configuration of a network management apparatus;

FIG. 3 is a diagram illustrating a configuration of a gateway;

FIG. 4 is a diagram illustrating a configuration of a wireless communication apparatus;

FIG. 5 is a diagram illustrating a hierarchical structure of software in the wireless communication apparatus;

FIG. 6 is a diagram illustrating a configuration of an ad hoc network;

FIG. 7 is a diagram illustrating an example of adjacent node information held by Node A;

FIG. 8 is a flowchart illustrating an exemplary algorithm of path determination;

FIG. 9 is a flowchart illustrating an exemplary algorithm of path determination specifying Node D as a destination;

FIG. 10 is a diagram illustrating an example of a routing table;

FIG. 11 is a diagram illustrating a method of obtaining management information;

FIG. 12 is a diagram illustrating an example of management information of Node A;

FIG. 13 is a diagram illustrating the case of changing a type of line in accordance with link quality;

FIG. 14 is a diagram illustrating the case of changing color of line in accordance with a link quality;

FIG. 15 is a diagram illustrating the case of changing a width of line in accordance with a link quality;

FIG. 16 is a diagram illustrating a link quality between nodes for each information transmission direction;

FIG. 17 is a diagram illustrating the case where link quality information of a link selected by a user is displayed;

FIG. 18 is a diagram illustrating the case of changing an attribute of a dummy image in accordance with a path;

FIG. 19 is a diagram illustrating the case of changing the number of dummy images in accordance with a link quality;

FIG. 20 is a diagram illustrating the case of changing a moving speed of dummy images in accordance with a link quality;

FIG. 21 is a diagram illustrating the case of displaying a path using an arrow; and

FIG. 22 is the case of changing an attribute of an arrow display in accordance with a link quality.

### DESCRIPTION OF THE PREFERRED EMBODIMENTS

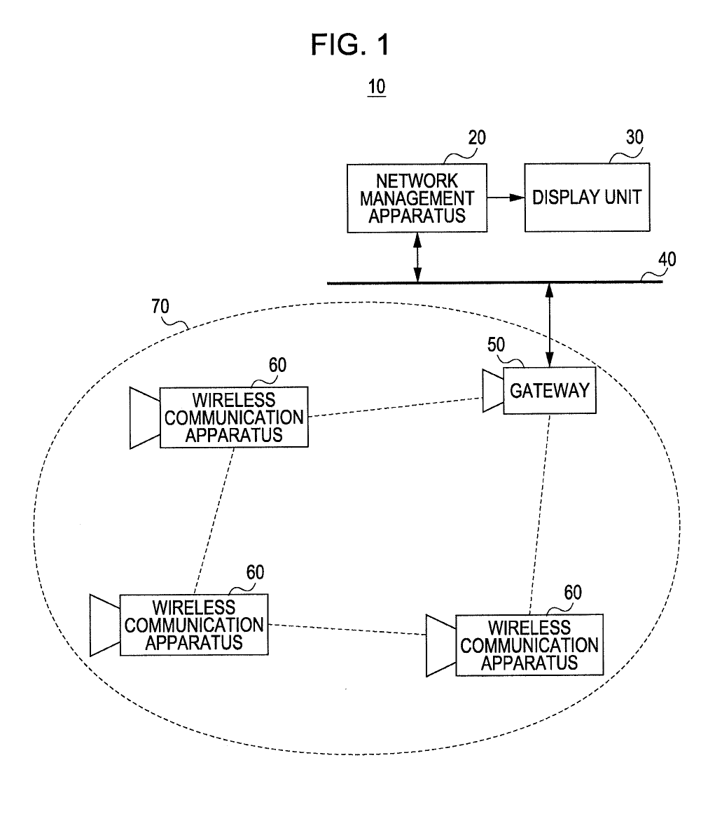

In the following, a description will be given of an embodiment of the present invention with reference to the drawings. FIG. 1 illustrates an example of a configuration of a network system. The network system 10 includes a network management apparatus 20, a display unit 30, a wired network 40, and an ad hoc network 70 including a gateway 50 and a plurality of wireless communication apparatuses 60.

The network management apparatus 20 supplies various kinds of information, etc., on the ad hoc network 70 to a user. The network management apparatus 20 obtains information from the gateway 50 and the wireless communication apparatus 60 through the wired network 40, generates a network configuration diagram, etc., of the ad hoc network 70 on the basis of the obtained information, generates a display signal indicating a diagram, etc., and supplies the signal to the display unit 30. The display unit 30 displays an image on the basis of the display signal from the network management apparatus.

The gateway 50 allows communication between the wired network 40 and the ad hoc network 70. The wireless communication apparatus 60 has a function of performing wireless communication with another wireless communication apparatus and the gateway, and a relay function of transferring data transmitted from one wireless communication apparatus to another wireless communication apparatus. In this regard, the gateway 50 may be disposed in a wireless communication apparatus 60.

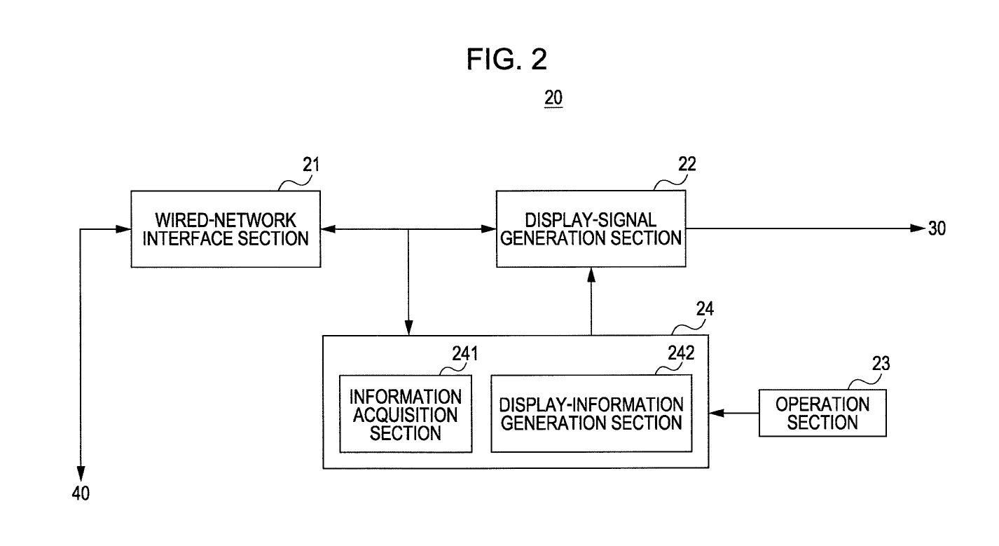

FIG. 2 illustrates a configuration of the network management apparatus 20. The network management apparatus 20 includes a wired network interface section 21, a display signal generation section 22, an operation section 23, and a network management control section 24.

The wired network interface section 21 is an interface for connecting the network management apparatus 20 to the wired network 40.

The display signal generation section 22 generates a display signal in a format supporting the display unit 30 on the basis of image data obtained through the wired network interface section 21 and image data supplied from the network management control section 24, and supplies the signal to the display unit 30. For example, as described below, when a monitoring system is constructed as the wireless communication apparatus 60 by providing an imaging apparatus, such as a monitoring camera, etc., with a wireless communication function, the display signal generation section 22 generates a display signal on the basis of image data of a captured image obtained through the wired network interface section 21, and supplies the display signal to the display unit 30. Also, the display-signal generation section 22 generates a display signal on the basis of image data of a network configuration diagram supplied from the network management control section 24, and supplies the display signal to the display unit 30. In this regard, in order to construct a monitoring system, a monitoring apparatus is constructed by the network management apparatus 20 and the display unit 30.

The operation section 23 includes an operation keys, a pointing device, etc., generates an operation signal in accordance with a user's operation, and supplies the signal to the network management control section 24.

The network management control section 24 has an information acquisition section 241 and a display-information generation section 242. The information acquisition section 241 obtains path information and link quality information from a plurality of wireless communication apparatuses operating in an ad hoc mode and a gateway. For example, the information acquisition section 241 obtains path information and link quality information by making a request to the gateway 50 through the wired network interface section 21 and the wired network 40 as described below. The display-information generation section 242 generates a network configuration diagram showing a link state among wireless terminals from the obtained path information. Further, the display-information generation section 242 changes a display attribute indicating an established link in accordance with the link quality information. For example, as described below, an established link is indicated by a line, and an attribute of the line is changed in accordance with the link quality. The display-information generation section 242 supplies image data showing a network configuration diagram in which a display attribute is changed in accordance with the link quality information to the display-signal generation section 22. Further, the network-management control section 24 obtains management information and controls generation of display information on the basis of the operation signal from the operation section 23, and displays information desired by the user, etc., to the display unit 30.

In this regard, the network-management control section 24 may be implemented by software. In this case, the network-management control section 24 includes a CPU (Central Processing Unit), a ROM (Read Only Memory), a RAM (Random Access Memory), etc. The CPU executes programs stored in the ROM and the RAM, and performs processing for obtaining path information and link quality information from a plurality of wireless terminals operating in an ad hoc mode, processing for generating a network configuration diagram indicating a link state among wireless terminals from the obtained path information, and processing for changing a display attribute indicating an established link in accordance with the link quality information. Further, the network-management control section 24 performs processing for displaying the user's desired information, etc., to the display unit 30 on the basis of the operation signal from the operation section 23.

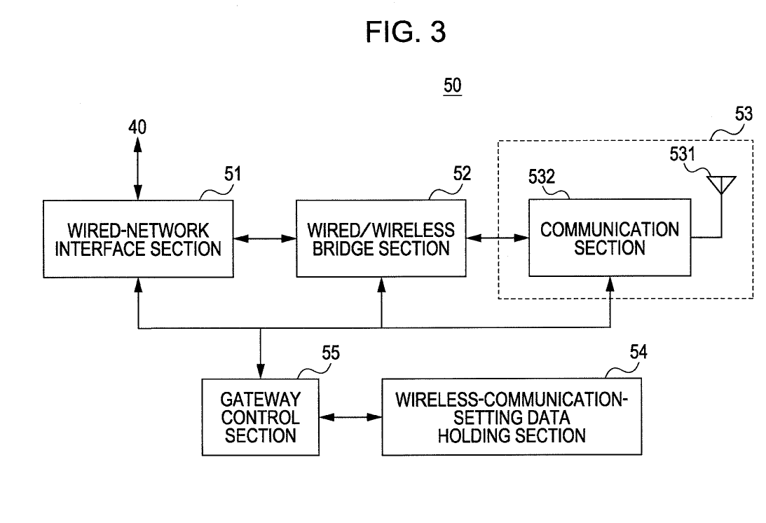

FIG. 3 illustrates an example of a configuration of the gateway 50. The gateway 50 includes a wired network interface section 51, a wired/wireless bridge section 52, a wireless network interface section 53, a wireless communication setting data holding section 54, and a gateway control section 55.

The wired network interface section 51 is an interface for connecting the gateway 50 to the wired network 40. The wired/wireless bridge section 52 performs protocol conversion, etc., between the wired network 40 and the ad hoc network 70, etc. The wireless network interface section 53 is an interface for connecting the gateway 50 to the ad hoc network 70, and includes an antenna 531, a communication section 532 performing transmission/reception of a radio signal, etc. In this regard, one or a plurality of antennas and communication sections may be disposed.

The wireless communication setting data holding section 54 holds various kinds of data for performing wireless communication. The wireless communication setting data holding section 54 holds, for example a MAC address of the gateway 50, security setting data, etc. Also, the wireless communication setting data holding section 54 holds a routing table and link quality information. The routing table is a table including a list of paths for data to reach a destination wireless terminal in the ad hoc network 70. The link information is information indicating, for example an S/N ratio, a packet (frame) loss ratio, a packet (frame) delay time, etc. Further, the wireless communication setting data holding section 54 holds management information on the ad hoc network 70. This management information is not fixed, and is changed in accordance with a change in links in the ad hoc network 70, etc. In this regard, a detailed description will be given of the management information later.

The gateway control section 55 performs overall operation of the gateway 50, and enables communication between an apparatus connected to the wired network 40 and an apparatus included in the ad hoc network 70. Also, gateway control section 55 performs processing for supplying the management information held by the wireless communication setting data holding section 54 to the network management apparatus 20.

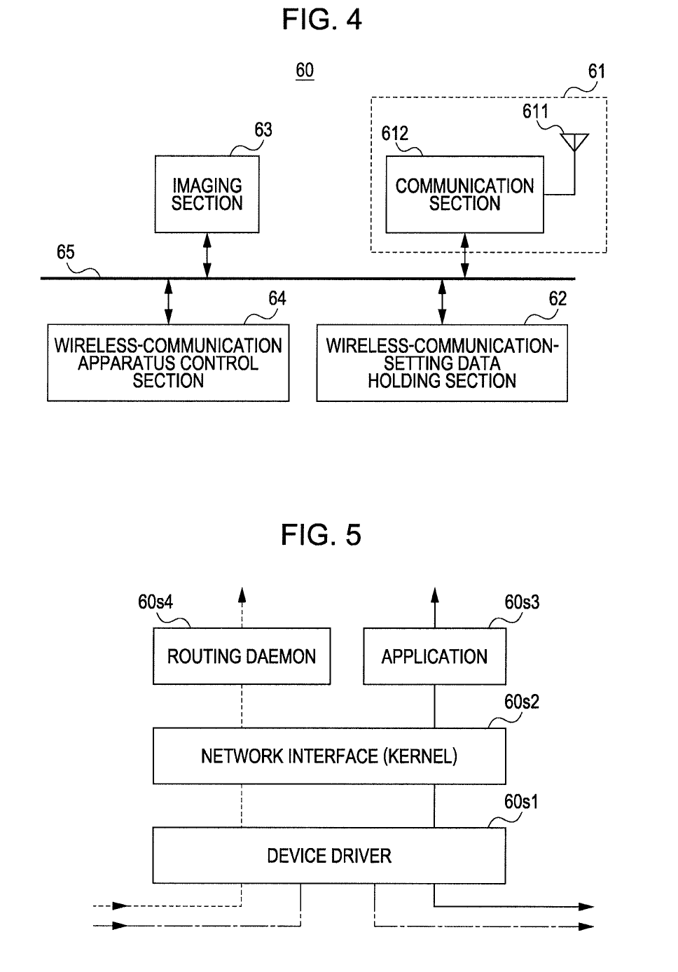

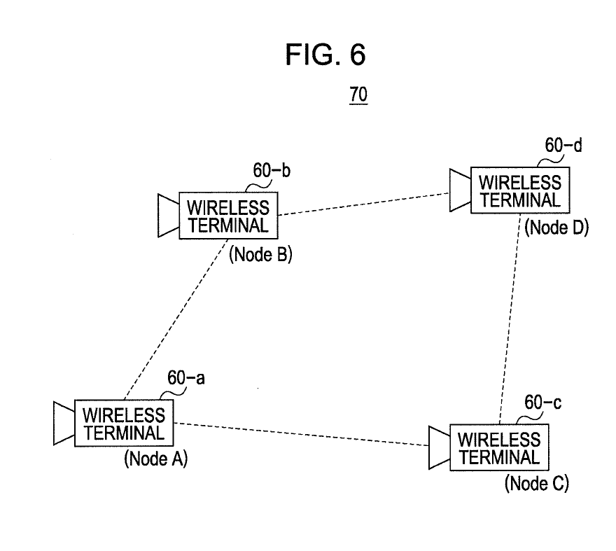

FIG. 4 illustrates an example of a configuration of the wireless communication apparatus 60. In this regard, FIG. 4 shows an example in which the wireless communication apparatus 60 is constructed by providing an imaging apparatus, such as a monitoring camera, etc., with a function of wireless communication, for example.

The wireless communication apparatus 60 includes a wireless network interface section 61, a wireless communication setting data holding section 62, an imaging section 63, and a wireless communication apparatus control section 64. Each section is connected with one another through a bus 65.

The wireless network interface section 61 is an interface for connecting the wireless communication apparatus 60 to the ad hoc network 70, and includes an antenna 611 and a communication section 612 performing transmission/reception processing of a wireless signal. In this regard, one or a plurality of the antennas and the communication sections may be disposed.

The wireless communication setting data holding section 62 holds various kinds of data for performing wireless communication. The wireless communication setting data holding section 62 holds, for example, a MAC address of a wireless communication apparatus 60 and security setting data, etc. Also, the wireless communication setting data holding section 62 holds the routing table and the link quality information. As described above, the routing table is a table including a list of paths for data to reach the gateway 50 or another wireless terminal in the ad hoc network 70. As described above, the link quality information is information indicating an S/N ratio, etc., for example.

The imaging section 63 includes a lens, an imaging device, a camera-signal processing section, etc., and generates a moving image, or captured image data of a still image.

The wireless communication apparatus control section 64 performs overall control of the wireless communication apparatus 60. For example, the wireless communication apparatus control section 64 performs transmission processing of capture image data generated by the imaging section 63 to the gateway 50, etc. Also, when an image-capture operation control signal is supplied from the gateway 50, etc., the wireless communication apparatus control section 64 controls an image-capture operation of the imaging section 63 on the basis of the image-capture operation control signal. Further, the wireless communication apparatus control section 64 performs processing, such as generation of the link quality information, update of information held by the wireless communication setting data holding section 62, transmission of information to another wireless communication apparatus, etc., and the like on the basis of the reception result by the wireless network interface section 61.

FIG. 5 illustrates a hierarchical structure of software in the wireless communication apparatus 60. The wireless communication apparatus 60 includes a device driver 60s1, a network interface 60s2, an application 60s3, and a routing daemon 60s4. The device driver 60s1 is software for driving hardware, such as a communication section 612 performing communication, etc. The network interface 60s2 is software for managing wireless communication processing, application processing, and performing memory management, etc., in the wireless communication apparatus 60. The application 60s3 is software for causing the imaging apparatus to perform desired image-capturing operation, etc., when the wireless communication apparatus 60 includes, for example, the imaging apparatus provided with a function of wireless communication. The routing daemon 60s4 is software for performing generation processing, update processing, etc., of a routing table to be used in wireless communication.

The wireless communication apparatus 60 performs wireless communication, determines adjacent wireless communication apparatuses, and performs update of the routing table in accordance with the link quality with the determined wireless communication apparatuses, etc. A processing flow at this time is shown by a broken line in FIG. 5. Also, when the wireless communication apparatus 60 transmits, for example image data of a still image or a moving image, in order to correctly transmit the image data to a desired destination, the wireless communication apparatus 60 transmits the image data as a radio signal with specifying an adjacent wireless communication apparatus on the basis of the routing table. A processing flow at this time is shown by a solid line in FIG. 5. Further, when received data indicates that a destination is another apparatus, the wireless communication apparatus 60 determines a path corresponding to a destination of the data from the routing table, transmits the data as a radio signal with specifying an adjacent wireless communication apparatus corresponding to the path. A processing flow at this time is shown by a dash-single-dot line in FIG. 5.

In this regard, the wireless communication apparatus 60 is not limited to an imaging apparatus with a wireless communication function as shown in FIGS. 4 and 5. The following devices may be used as the wireless communication apparatus 60: for example, home information appliances (a television receiver, a refrigerator, an air conditioner, a microwave oven, a telephone, a video recorder, etc.), a mobile information terminal (a mobile computer, a cellular phone, a portable game machine, an electronic book, etc.), a display unit, a printer, a game machine, a general purpose computer, a portable music player, and the like. Also, the wireless communication apparatus 60 including the above-described function of the gateway 50 may be used. In the following, a description will be given by defining the gateway 50 and the wireless communication apparatus 60 generically as a wireless terminal.

Next, a description will be given of operation of an ad-hoc network system. In an ad-hoc network system, routing, which determines through which wireless terminal data is transmitted, is performed by a routing protocol.

In a routing protocol, messages are exchanged between wireless terminals, and a routing table is generated. For example, in OLSR (Optimized Link State Routing), which is a routing protocol, a wireless terminal broadcasts a packet called a HELLO message including an address of itself, and detects an adjacent wireless terminal on the basis of a response from another wireless terminal. In this regard, the response includes an address of the wireless terminal having made a response. Each wireless terminal can grasp addresses of adjacent wireless terminals by detecting the adjacent wireless terminals. Also, by including information of adjacent wireless terminals in a HELLO message, it becomes clear what kind of wireless terminals are connected beyond the adjacent wireless terminal, and thus a wireless terminal holds this information. Further, in the OLSR protocol, a TC message, which is flooded over an entire network, is used. The TC message informs each wireless terminal of a topology of the entire network.

Each wireless terminal transmits and receives these messages, and generates and holds a routing table on the basis of information of received messages. Also, by repeating the transmission and the reception of these messages, each wireless terminal can update the routing table to be in a correct state even if a wireless terminal is moved, etc. Further, a wireless terminal can perform optimum routing by including link quality information in the messages.

Next, a brief description will be given of a path calculation algorithm. In this regard, the below description will be given on the assumption that the ad hoc network 70 includes, for example, four wireless terminals 60-a, 60-b, 60-c, and 60-d (for example, a gateway 50), and the wireless terminal 60-a is called Node A, and the wireless terminals 60-b, 60-c, and 60-d are called Node B, Node C, and Node D, respectively. In this regard, Node A is assumed to hold adjacent node information on the adjacent nodes obtained by transmitting and receiving messages as described above.

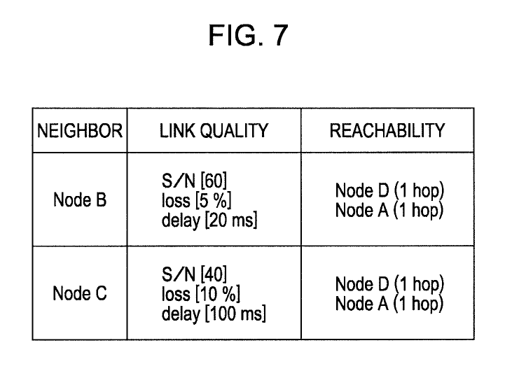

FIG. 7 illustrates an example of adjacent node information held by Node A. For example, the adjacent information held by Node A indicates that the adjacent nodes (neighbors) are Node B and Node C. Also, the adjacent node information indicates, as link quality, an S/N ratio, a packet (frame) loss rate (in the following, simply called “loss”), and a delay time. Specifically, the link quality of the link established with Node B has an S/N ratio of “60”, a loss of “5%”, and a delay time of “20 ms”. The link quality of the link established with Node C has an S/N ratio of “40”, a loss of “10%”, and a delay time of “100 ms”. Further, the adjacent node information indicates reachability of adjacent nodes. Specifically, it is possible to reach from Node B to Node D and Node A. And it is possible to reach from Node C to Node D and Node A. Also, the adjacent node information indicates that the individual numbers of hops are “1”.

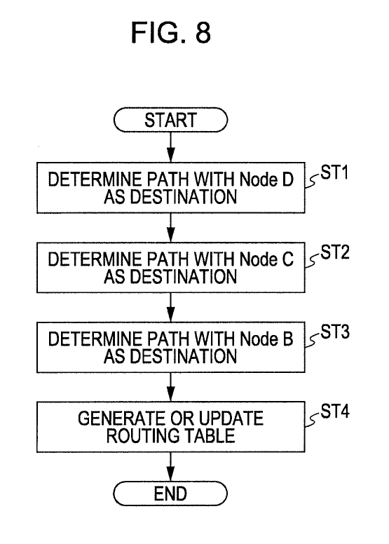

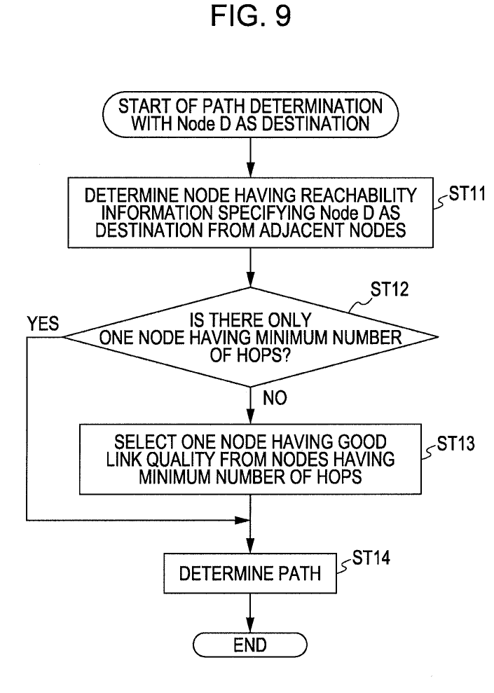

FIG. 8 is a flowchart illustrating an exemplary algorithm of path determination. For example, when Node A starts path determination using adjacent node information, and processing proceeds to step ST1, Node A performs path determination with Node D as a destination, for example. FIG. 9 is a flowchart illustrating an exemplary algorithm of path determination with Node D as the destination. In step ST11, Node A determines a node having reachability information specifying Node D as the destination from adjacent nodes. For example, the adjacent node information shown in FIG. 7 indicates that Node B and Node C are reachable to Node D. Thus, Node A determines Node B and Node C, and the processing proceeds to step ST12.

In step ST12, Node A determines whether there is only one node having a minimum number of hops. In the node determined in step ST11, Node A determines whether there is only one node having a minimum number of hops. If there are a plurality of nodes having a minimum number of hops, the processing proceeds to step ST13. If there is only one node having a minimum number of hops, the processing proceeds to step ST14. As described above, when Node A determines Node B and Node C in step ST11, the number of hops to Node D is all indicated as “1” by the adjacent node information of both nodes, and thus processing proceeds to step ST13.

In step ST13, Node A selects one node having a good link quality from nodes having a minimum number of hops, and the processing proceeds to step ST14. When link qualities of Node B and Node C are as shown in FIG. 7, Node A selects Node B having a good link quality, and the processing proceeds to step ST14.

In step ST14, Node A determines a path. That is to say, if there is only one node having a minimum number of hops, Node A determines a path using this node. Also, if there are a plurality of nodes having a minimum number of hops, Node A determines a path using a node having a best link quality. That is to say, when a destination is Node D, Node A selects Node B as a path. In this manner, when path determination specifying Node D as the destination is completed, the processing proceeds to step ST2 in FIG. 8.

In step ST2, Node A performs path determination specifying Node C as the destination. Here, Node A performs path determination specifying Node C as the destination by performing the same processing as that in FIG. 9. That is to say, since the adjacent node information indicates link establishment with Node C, Node A specifies Node C as a path, and the processing proceeds to step ST3.

In step ST3, Node A performs path determination specifying Node B as the destination. Here, Node A performs path determination specifying Node B as the destination by performing the same processing as that in FIG. 9. That is to say, since the adjacent node information indicates link establishment with Node B, Node A specifies Node B as a path, and the processing proceeds to step ST4.

In step ST4, Node A generates or updates the routing table. Node A generates a routing table indicating the path determined by the processing from step ST1 to ST3. Also, when Node A holds the routing table, Node A updates the routing table so as to specify the determined path.

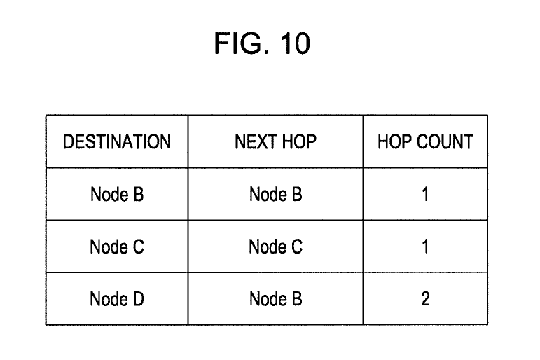

When path determination is carried out in this manner, Node A can generate a routing table shown in FIG. 10. For example, Node B, Node C, and Node D are shown as a destination. When the destination is Node B, Node B is to be used as a next hop. When the destination is Node C, Node C is to be used as a next hop. When the destination is Node D, Node B is to be used as a next hop. Also, when the destination is Node D, the number of hops is shown as “2”. In this regard, the other Node B, Node C, and Node D holds adjacent node information on adjacent nodes. By performing the above-described processing, it is possible to generate and update routing tables.

Next, when image data of a captured image is transmitted, for example, when the captured image is displayed on the display unit 30, a node generates transmission data by assembling the image data into packets and adding transmission source and destination addresses, etc., to generates transmission data. Also, the node determines the next hop node corresponding to the destination on the basis of the routing table. Further, the node changes the transmission data into a radio signal, and transmits the signal with specifying the determined node as the destination of the radio signal. Also, if the destination of the received radio signal indicates the node itself, the node receives the radio signal, and performs processing of transmitted data.

Further, if the destination of the received radio signal indicates the node itself, and an address indicating the transmission data destination is different from the own address of the node, the node performs relay processing. That is to say, if the destination of the received transmission data is stored in the routing table, the node transfers the transmission data to the next hop node determined on the basis of the routing table. In this regard, if the destination of the received transmission data is not stored in the routing table, the node discards the received transmission data.

In this manner, by performing data transmission/reception and relaying, it is possible to correctly transmit image data from a transmission-source node to a destination node. Also, in the same manner, it is possible to correctly transmit various kinds of data from a transmission-source node to a destination node.

A network management apparatus, which performs such management of an ad hoc network obtains management information necessary for network management from each node through a gateway.

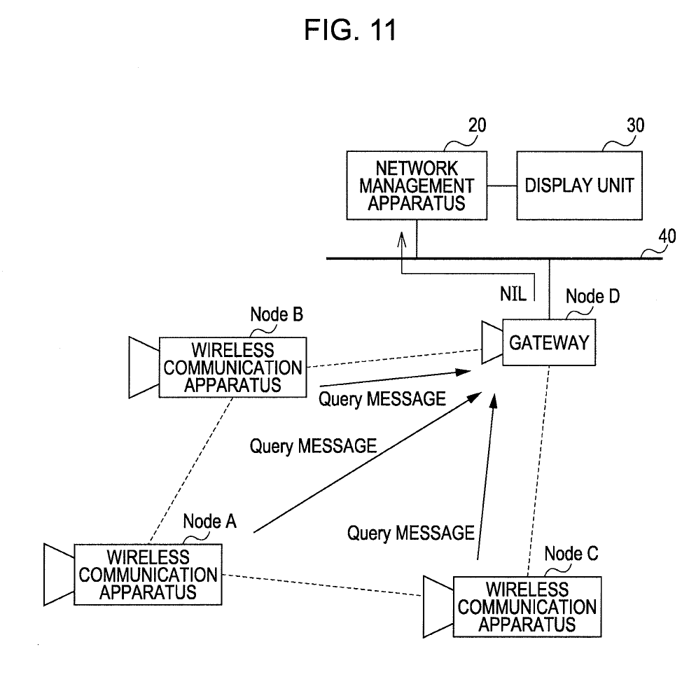

FIG. 11 is a diagram illustrating a method of obtaining management information. For example, Node D, which is operating as a gateway, transmits and receives query messages, and holds management information indicated by query messages supplied from Node A, Node B, and Node C as a management information list, for example. Also, the management information list includes management information of Node D.

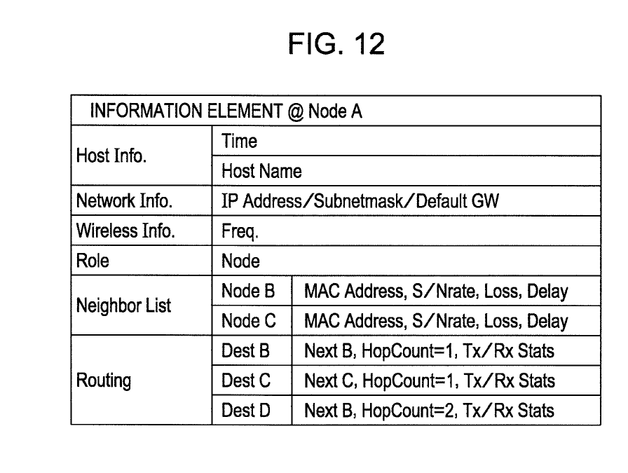

FIG. 12 is a diagram illustrating an example of management information of Node A. The management information includes “Host Info.”, “Network Info.”, “Wireless Info.”, “Role”, “Neighbor List”, and “Routing”.

In the management information, “Host Info.” shows time when a host name and management information is created. “Network Info.” shows an IP address and sub-net mask of Node A and an IP address of a default gateway. “Wireless Info.” shows a frequency to be used by wireless communication. “Role” shows a role in an ad-hoc network system, and indicates a node in FIG. 12.

“Neighbor List” shows adjacent nodes and link quality information with the adjacent nodes. In this regard, “Neighbor List” shows that the adjacent nodes of Node A are Node B and Node C. Also, “Neighbor List” shown in FIG. 12 shows MAC (Media Access Control) addresses of Node B and Node C, and link quality information, for example, S/N ratios and loss rates, and delay times when wireless communication is performed with Node B and Node C.

“Routing” shows information of a routing table. In this regard, “Routing” shown in FIG. 12 indicates that when the destination is Node B, Node B is used as an adjacent node, and the number of hops to the destination is “1”. Also, “Routing” shown in FIG. 12 indicates that when the destination is Node C, Node C is used as an adjacent node, and the number of hops to the destination is “1”. Further, “Routing” shown in FIG. 12 indicates that when the destination is Node D, Node B is used as an adjacent node, and the number of hops to the destination is “2”. Also, “Routing” shown in FIG. 12 indicates that links of Node B and Node C are in a state capable of transmission and reception.

Node D obtains management information as shown in FIG. 12 from Node B and Node C, and generates a management information list using the management information itself.

The network management apparatus 20 makes a request to Node D operating as a gateway for a management information list when carrying out network management. Also, when a request of a management information list is made from the network management apparatus 20, Node D supplies the holding management information list NIL to the network management apparatus 20.

By performing such processing, the network management apparatus 20 can obtain management information from each node included in the ad-hoc network system. In this regard, the network management apparatus 20 at least can obtain management information indicating a routing table and link quality, etc., from each node, and thus a method of generating a routing table and a management information list are not limited to the method described above. For example, a routing table may be generated using a protocol, such as AODV (Ad-hoc On-Demand Distance Vector), etc., for example.

Next, a description will be given of operation of the network management apparatus 20. The management information list includes a routing table and link quality information held by each node as described above. It is therefore possible for the network management apparatus 20 to determine how links are established among nodes, and what link quality of each link. Accordingly, the network management apparatus 20 generates a network configuration diagram showing link states among wireless terminals on the basis of the management information list obtained from Node D. Also, the network management apparatus 20 allows link quality to be identified by performing processing for changing display attributes in accordance with the link quality information. Further, the network management apparatus 20 supplies a display signal indicating a network configuration diagram after the processing to the display unit 30 in order to display the network configuration diagram. Also the network management apparatus 20 supplies image data supplied from a desired node through Node D, etc., to display an image captured by a desired imaging apparatus to the display unit 30. Also, the network management apparatus 20 processes the image signal supplied from a desired node to generate a display signal, thereby displays images captured by a plurality of imaging apparatuses in one screen, and performs processing for displaying the images with various kinds of information, etc.

The network configuration diagram indicates each node included in the ad hoc network 70, and how links are established among the nodes in a list. In this regard, the network management apparatus 20 detects a link state of each node on the basis of the management information list, and determines a display position of each node in the network configuration diagram. Also, if each node has position information, the network management apparatus 20 can display the display position of each node in the network configuration diagram correspondingly to an actual position using the position information. Here, position information may be obtained by using a positioning system, such as a GPS (Global Positioning System), etc. Also, a distance between nodes may be estimated from the communication result between the nodes, and a position of each node may be estimated using this distance.

The network management apparatus 20 displays links so that the user can easily identify a difference in the link qualities among nodes in the network configuration diagram. In the link display, a link established between nodes is indicated by a line, and attributes of the line are changed in accordance with the link quality. The changes in the attributes include, for example a change in the type of line, a change in color of a line, a change in the width of a line, etc.

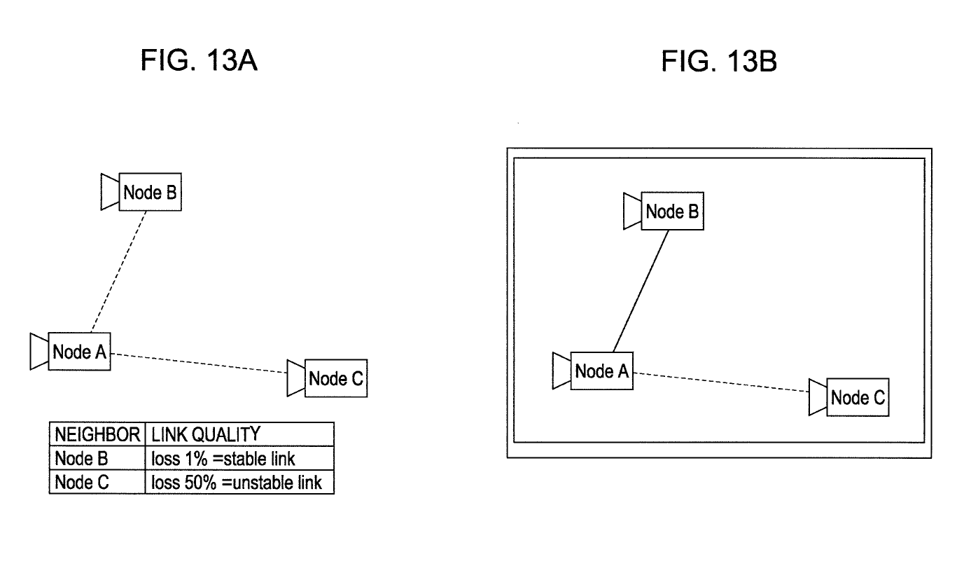

FIG. 13 is a diagram for explaining a method of displaying link quality in the network configuration diagram. FIG. 13 shows the case of changing a type of line in accordance with link quality. In this regard, in FIG. 13, for the sake of simplicity of description, only a part of the ad hoc network, for example, only Node A, Node B, and Node C are shown. Also, FIG. 13A shows link qualities when links are established between Node A and Node B, and Node A and Node C. FIG. 13B shows a network configuration diagram displayed on the display unit 30 by the network management apparatus 20.

The network management apparatus 20 determines a link between nodes as a stable link if link quality between the nodes is, for example a loss rate less than a predetermined threshold value. And if the link quality is not less than the threshold value, the network management apparatus 20 determines the link as an unstable link. Also, the network management apparatus 20 denotes a stable link by a solid line, and denotes an unstable link by a broken line.

Here, if the loss rate between Node A and Node B is “1%”, the loss rate between Node A and Node C is “50%”, and the threshold value is higher than “1%”, and not higher than “50%”, the network management apparatus 20 determines that the link between Node A and Node B, which has a loss rate less than the threshold value, is a stable link, and determines that the link between Node A and Node C, which has a loss rate not less than the threshold value, is an unstable link. Accordingly, the network management apparatus 20, which has a loss rate not greater than the threshold value, connects Node A and Node B by a solid line and connects Node A and Node C by a broken line in the network configuration diagram. In the manner, the user can easily distinguish a stable link from an unstable link depending on by what type of line the nodes are connected in the network configuration diagram. In this regard, in FIG. 13, two types of line are used. However, link quality may be classified into three classes or more, and different type of line may be used for each class by providing a plurality of threshold values for the loss rate. For example, the intervals of the broken line may be widened along with deterioration of the loss rate, a line, such as a dash-single-dot line, a dash-double-dot line, etc., may be used.

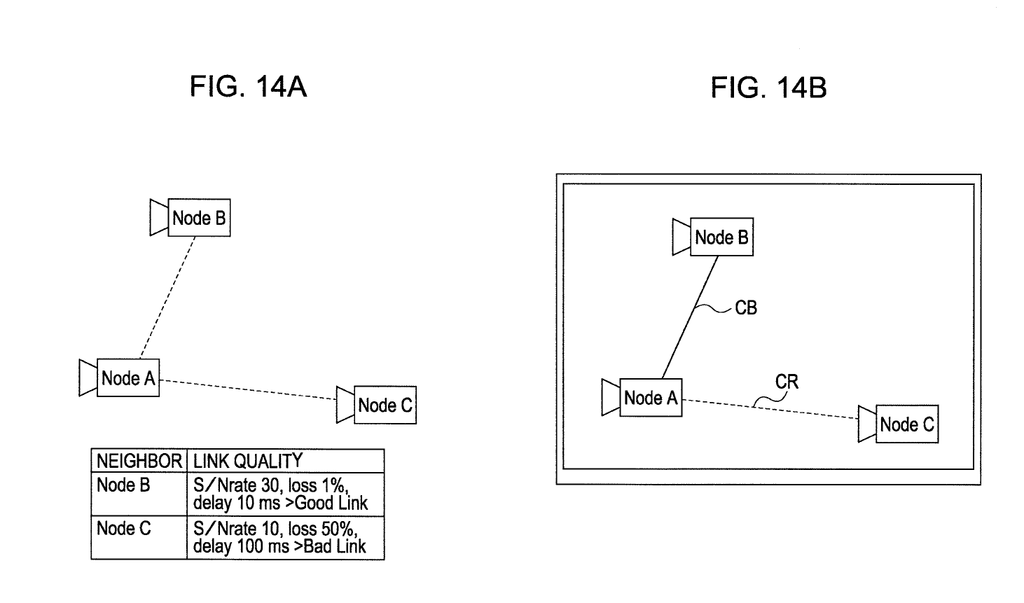

FIG. 14 is a diagram illustrating the case of changing color of line in accordance with a link quality. In this regard, in FIG. 14, only Node A, Node B, and Node C are shown in the same manner as in FIG. 13. Also, FIG. 14A shows link qualities when links are established between Node A and Node B, and Node A and Node C. FIG. 14B shows a network configuration diagram displayed by the network management apparatus 20.

The network management apparatus 20 determines a link between nodes as a good link if link quality between the nodes is, for example a delay time less than a predetermined threshold value. And if the link quality is not less than the threshold value, the network management apparatus 20 determines the link as a bad link. Also, the network management apparatus 20 denotes a good link by blue (CB), for example, and denotes a bad link by red (CR).

Here, if the delay time between Node A and Node B is “10 ms”, the delay time between Node A and Node C is “100 ms”, and the threshold value is greater than “10 ms” and is not higher than “100 ms”, the network management apparatus 20 determines that the link between Node A and Node B, which has a delay time less than the threshold value, is a good link, and determines that the link between Node A and Node C, which has delay time not less than the threshold value, is a bad link. Accordingly, the network management apparatus 20 displays the line connecting Node A and Node B by blue (CB) and displays the line connecting Node A and Node C by red (CR) in the network configuration diagram. In the manner, the user can easily distinguish a good link from a bad link depending on by what color of a line the nodes are connected in the network configuration diagram. In this regard, in FIG. 14, two colors are used. However, link quality may be classified into three classes or more, and different color may be used for each class by providing a plurality of threshold values for the delay time. For example, green or yellow, etc., may be used. Also, the network management apparatus 20 may change hue, chroma, or brightness as a difference in color.

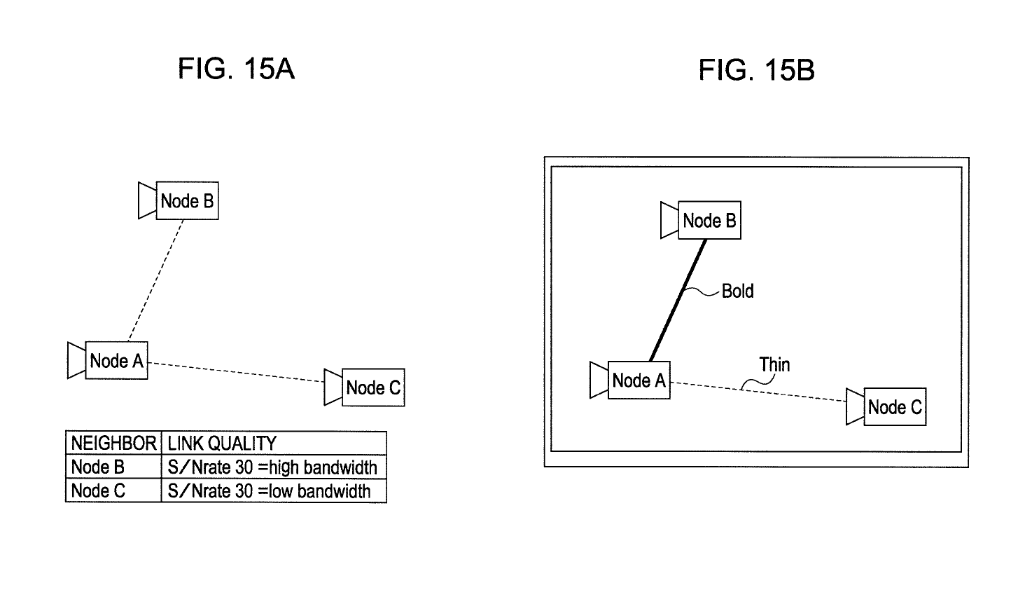

FIG. 15 is a diagram illustrating the case of changing a line width in accordance with a link quality. In this regard, in FIG. 15, only Node A, Node B, and Node C are shown in the same manner as in FIG. 13. Also, FIG. 15A shows link qualities when links are established between Node A and Node B, and Node A and Node C. FIG. 15B shows a network configuration diagram displayed by the network management apparatus 20.

The network management apparatus 20 determines a link between nodes as a bold link if link quality between the nodes is, for example an S/N ratio not lower than a predetermined threshold value. And if the link quality is lower than the threshold value, the network management apparatus 20 determines the link as a thin link. Also, the network management apparatus 20 indicates a bold link by a wide line, for example, and indicates a thin link by a narrow line.

Here, if the S/N ratio between Node A and Node B is “30”, the S/N ratio between Node A and Node C is “10”, and the threshold value is higher than “10” and not higher than “30”, the network management apparatus 20 determines that the link between Node A and Node B, which has an S/N ratio not less than the threshold value, is a bold link, and determines that the link between Node A and Node C, which has an S/N ratio less than the threshold value, is a thin link. Accordingly, the network management apparatus 20 displays a line connecting Node A and Node B by a wide line and a line connecting Node A and Node C by a narrower line than the line connecting Node A and Node B in the network configuration diagram. In the manner, the user can easily distinguish a wide-band link from a narrow-band link depending on by what width of a line the nodes are connected in the network configuration diagram. In this regard, in FIG. 15, two line widths are used. However, link quality may be classified into three classes or more, and different line width may be used for each class by providing a plurality of threshold values for the S/N ratio. For example, the line width may be narrowed along with deterioration of the S/N ratio.

When wireless communication is performed between nodes, link qualities are sometimes different between the case of transmitting data from one of the nodes to the other of the nodes and the case of transmitting data from the other of the nodes to one of the nodes. For example, when there are differences in performance of a transmission/reception section performing transmission and reception of radio signals between the nodes, if reception performance of one of the nodes is lower than the other of the nodes, a link quality may deteriorate in the case where one of the nodes receives data transmitted from the other of the nodes compared to the case where one of the nodes transmits data to the other of the nodes.

Thus, the network management apparatus 20 may display the link qualities between nodes by two lines. In this case, either of the lines can be identified to be corresponding to either of the data transmission directions. For example, the data transmission direction is explicitly expressed as an arrow line.

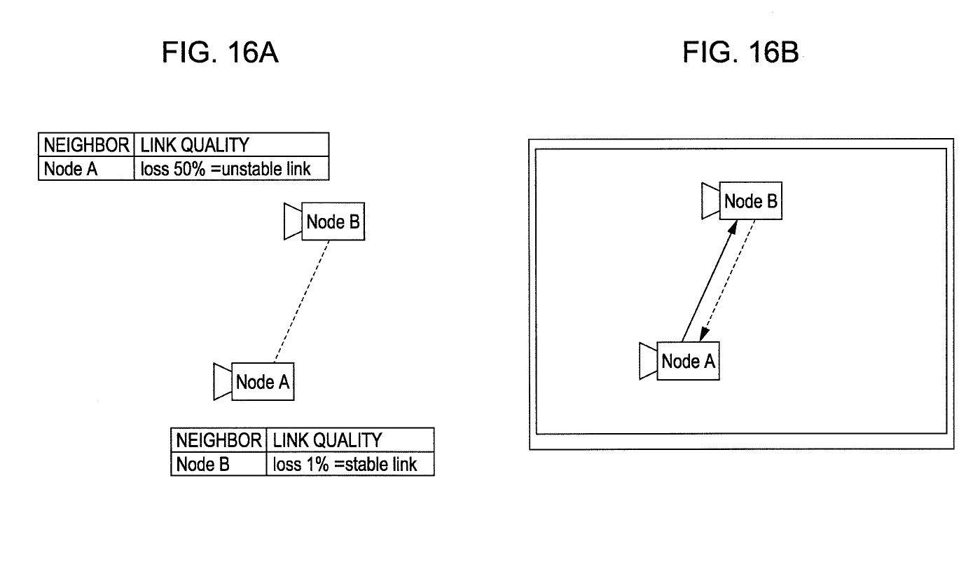

FIG. 16 is a diagram illustrating the case of displaying link qualities between the nodes for each data transmission direction. In this regard, in FIG. 16, only Node A and Node B are shown. Also, FIG. 16A shows link qualities between Node A and Node B, and Node A and Node C. FIG. 16B shows a network configuration diagram displayed by the network management apparatus 20.

Here, if the loss rate of data transmission from Node A to Node B is “1%”, the loss rate of the transmission from Node B to Node A is “50%”, and the threshold value is higher than “1%” and not higher than “50%”, the network management apparatus 20 determines that the link of the transmission from Node A to Node B is a stable link, and determines that the link of transmission from Node B and Node A is an unstable link. Accordingly, the network management apparatus 20 displays the link between Node A and Node B using a solid arrow line having a direction from Node A to Node B and a broken arrow line having a direction from Node B to Node A in the network configuration diagram. In the manner, the user can easily distinguish a stable link from an unstable link for each data transmission direction depending on by what type of a line the nodes are connected in the network configuration diagram.

Also, in the network management apparatus 20, the operation section 23 and the display unit 30 may constitute a GUI. When the user selects a link, the network management apparatus may display link quality information of the selected link.

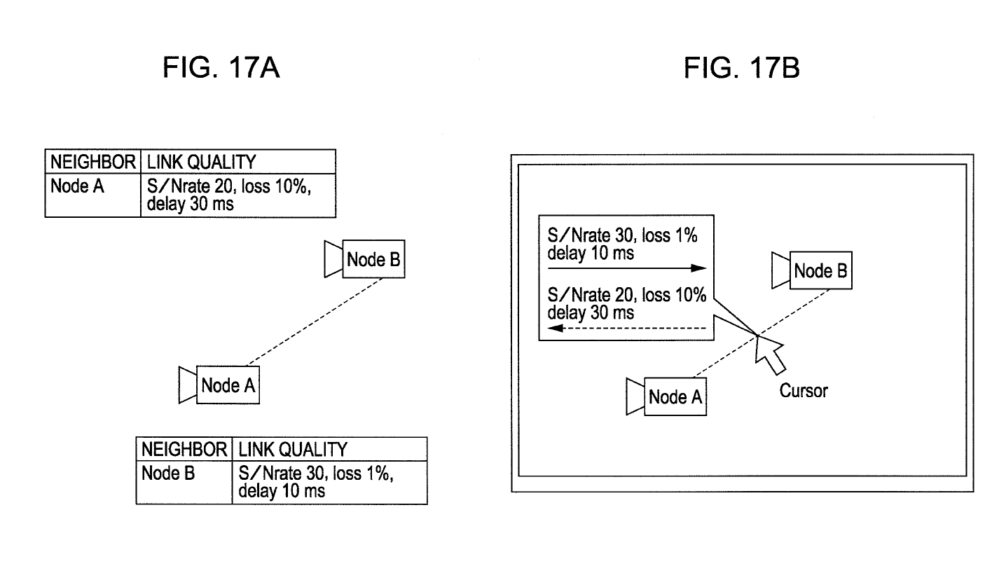

FIG. 17 is a diagram illustrating the case where link quality information of a link selected by the user is displayed. In this regard, in FIG. 17, only Node A and Node B are shown. Also, FIG. 17A shows link qualities between Node A and Node B, and Node A and Node C. FIG. 17B shows a network configuration diagram displayed by the network management apparatus 20. In this regard, when data is transmitted from Node A to Node B, the S/N ratio is “30”, the loss rate is “1%”, and the delay time is “10 ms”. When data is transmitted from Node B to Node A, the S/N ratio is “20”, the loss rate is “10%”, and the delay time is “30 ms”.

The network management apparatus 20 displays a cursor on the screen, and when the user performs operation on the operation section, the cursor is moved in accordance with the user operation. For example, the network management apparatus 20 determines that the user has selected the link established between Node A and Node B when the cursor is placed on a line connecting Node A and Node B, and displays the link quality information of this link as shown in FIG. 17B. In this regard, FIG. 17B shows an example of the case where the S/N ratio, the loss rate, and the delay time are displayed for each transmission direction.

In a network configuration diagram, if link quality information of all the links is displayed in detail, too much information is displayed, and thus the network configuration diagram becomes complicated. However, in the network management apparatus 20, when the user selects a link, only the link quality information of the selected link is displayed in detail. Thus, the link quality information can be displayed in detail only when it is necessary for the user. Accordingly, it is possible to display the network management information whose display content is easy to read, and from which necessary information can be efficiently obtained.

In this regard, FIGS. 13 to 16 show the case where one attribute of a line is changed in accordance with one piece of information in the link quality information. However, a combination of a plurality of attributes of a line may be changed in accordance with the link quality information. Also, in FIG. 17, an attribute of the line which connects Node A and Node B may be changed in accordance with the link quality information as described above. In this case, it becomes possible to grasp the general quality state of each link by the difference in the attribute of a line. Further, it becomes possible to obtain the detailed link quality information of the link desired by the user.

Next, a description will be given of the case where a link is displayed so that a difference in the link quality between nodes can be easily identified, but also a path can be easily identified.

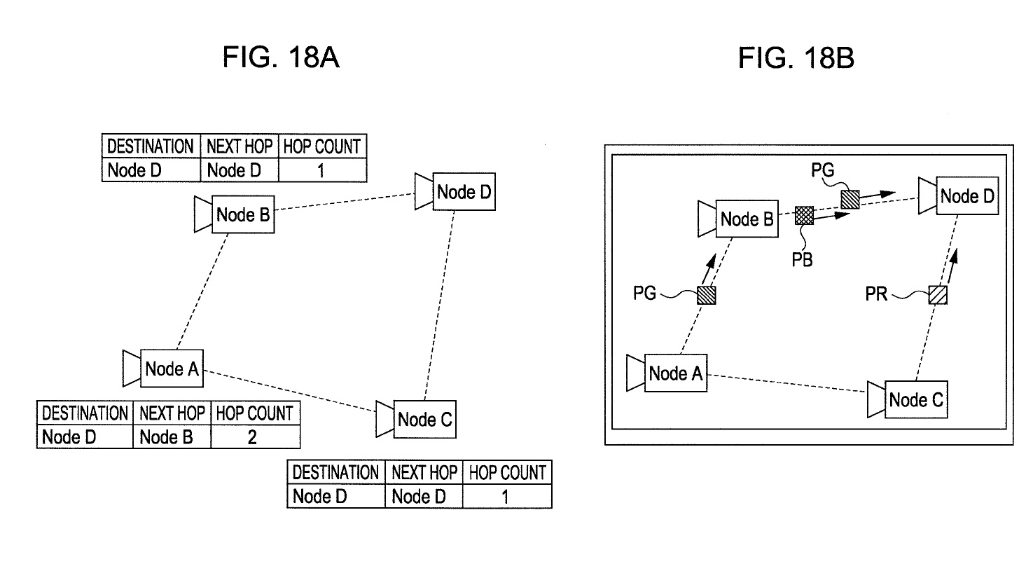

FIG. 18 illustrates the case where a dummy image simulating a data unit, for example a packet, is disposed in the network configuration diagram, and an attribute of the dummy image is changed depending on a path. In this regard, FIG. 18 shows Node A, Node B, Node C, and Node D. FIG. 18A shows a part of the routing table of Node A, Node B, and Node C. FIG. 18B shows a network configuration diagram displayed by the network management apparatus 20.

Here, the routing table of Node A indicates when the destination of Node D, the adjacent node is Node B. Also, the routing table of Node B indicates when the destination of Node D, the adjacent node is Node D. And the routing table of Node C indicates when the destination of Node D, the adjacent node is Node D.

In this case, as shown in FIG. 18B, the network management apparatus 20 allows a link used for data transmission to be identified by disposing, for example a rectangular dummy image. In this manner, by disposing a dummy image in the network configuration diagram, it becomes possible for the user to easily grasp a data transmission path.

Through the link from Node B to Node D, not only data specifying Node D as destination is transmitted from Node B, but also data specifying Node D as destination from Node A is relayed and transmitted. Thus, the network management apparatus 20 may allow the user to easily grasp a transmission path for each data by changing the attribute of a dummy image for each data transmission path from a transmission source to a destination, for example, by changing color of the dummy image.

For example, in the network configuration diagram, the network management apparatus 20 allows a link, which is used for transmitting data from Node A to Node D through Node B, to be identified by disposing a green dummy image PG. That is to say, the network management apparatus 20 disposes the dummy image PG between Node A and Node B, and between Node B and Node D. Also, the network management apparatus 20 allows a link, which is used for transmitting data from Node B to Node D, to be identified by disposing a blue dummy image PB. Further, the network management apparatus 20 allows a link, which is used for transmitting data from Node C to Node D, to be identified by disposing a red dummy image PR.

In this manner, the network management apparatus 20 allows a data link from a transmission source to a destination by disposing a dummy image having a different color for each data transmission path. Thus, it is possible for the user to easily grasp a transmission path for each data by what color of dummy image is disposed on between which nodes. Also, the shape of the dummy image may be changed. For example, not only a rectangular dummy image, but also circular, triangular dummy images, etc., may be used. Also, in the case of using a triangular dummy image, data transmission direction can be indicated by a direction of a triangle.

Also, the amount of data transmitted between nodes differs depending on a link quality. For example, it is possible for a link having a high S/N ratio to transmit more data per unit time compared to a link having a low S/N ratio as described above. Thus, it becomes possible to identify not only a transmission path but also a link quality by changing an attribute of the dummy image, for example the number of dummy images in accordance with the link quality.

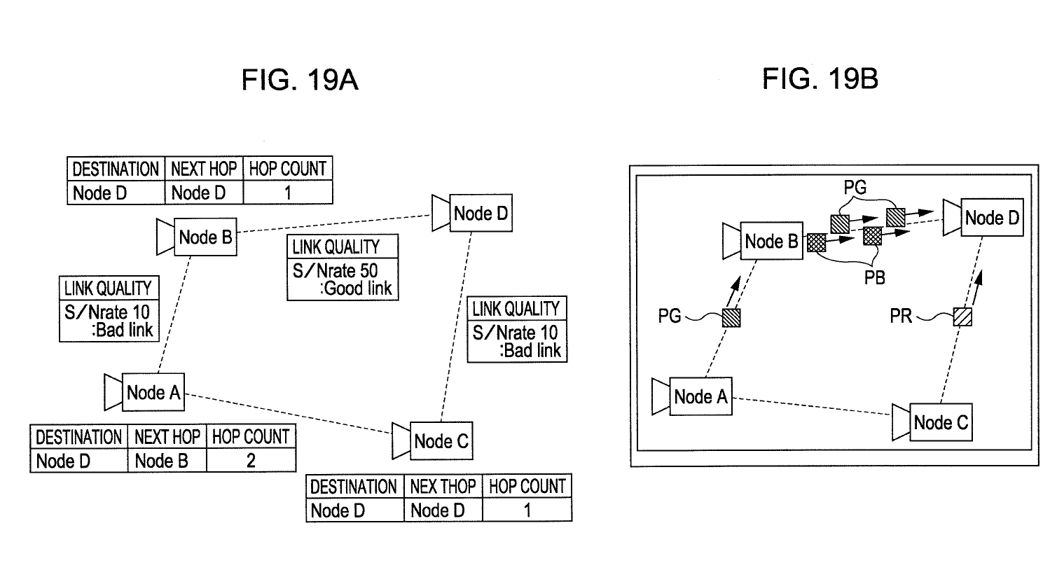

FIG. 19 illustrates the case of changing the number of dummy images depending on a link quality. In this regard, FIG. 19 shows Node A, Node B, Node C, and Node D. Also, FIG. 19A shows a part of the routing table of Node A, Node B, and Node C, and link qualities, for example the S/N ratio. FIG. 19B shows a network configuration diagram displayed by the network management apparatus 20.

Here, the routing table of Node A indicates when the destination of Node D, the adjacent node is Node B. Also, the routing table of Node B indicates when the destination of Node D, the adjacent node is Node D. And the routing table of Node C indicates when the destination of Node D, the adjacent node is Node D. Also, the S/N ratio of the link between Node A and Node D is “10”, the S/N ratio of the link between Node B and Node D is “50”, and the S/N ratio of the link between Node C and Node D is “10”.

In this case, the network management apparatus 20 changes the number of dummy images disposed between nodes in accordance with the S/N ratio. That is to say, it is possible for a link having a high S/N ratio to transmit more data per unit time compared to a link having a low S/N ratio. Thus, the network management apparatus 20 increases the number of dummy images disposed between nodes for a link having a high S/N ratio, and decreases the number of dummy images disposed between nodes for a link having a low S/N ratio. For example, as shown in FIG. 19B, the number of the dummy images PG and PB between Node B and Node D is set to be larger than the number of the dummy images PG between Node A and Node B, and the number of the dummy images PR between Node C and Node D. In this manner, it becomes possible for the user to grasp whether a link can transmit a large amount of data per unit time if the number of dummy images is changed.

Also, if a display position of a dummy image is moved in a data transmission direction, the network management apparatus 20 allows the user to easily grasp the data transmission direction by determining which direction the dummy image is moving. Further, the network management apparatus 20 may change a moving speed of a dummy image in accordance with a link quality.

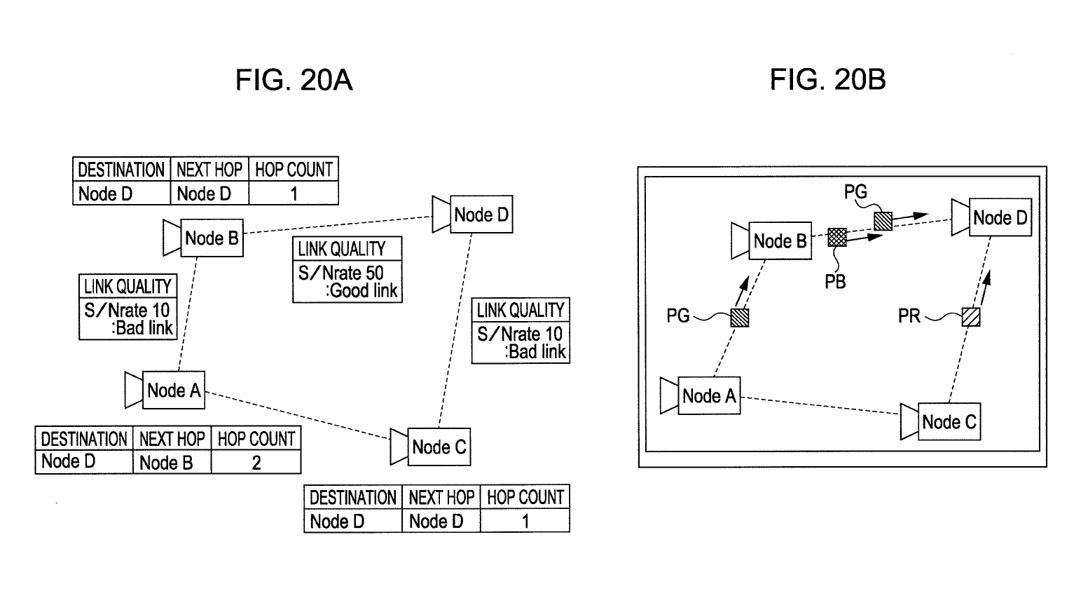

FIG. 20 illustrates the case of changing a moving speed of dummy images depending on a link quality. In this regard, FIG. 20 shows Node A, Node B, Node C, and Node D. Also, FIG. 20A shows a part of the routing table of Node A, Node B, and Node C, and link qualities, for example the S/N ratio. FIG. 20B shows a network configuration diagram displayed by the network management apparatus 20.

Here, the routing table of Node A indicates when the destination of Node D, the adjacent node is Node B. Also, the routing table of Node B indicates when the destination of Node D, the adjacent node is Node D. And the routing table of Node C indicates when the destination of Node D, the adjacent node is Node D. Also, the S/N ratio of the link between Node A and Node D is “10”, the S/N ratio of the link between Node B and Node D is “50”, and the S/N ratio of the link between Node C and Node D is “10”.

In this case, the network management apparatus 20 changes a moving speed of the dummy image disposed between nodes in accordance with the S/N ratio. That is to say, it is possible for a link having a high S/N ratio to transmit more data per unit time compared to a link having a low S/N ratio. That is to say, the network management apparatus 20 gives a higher moving speed of the dummy images disposed between nodes to a link having a high S/N ratio than to a link having a low S/N ratio because the data transmission speed is high. For example, as shown in FIG. 20B, the moving speed of the dummy images PG and PB indicating a link between Node B and Node D, which has a high S/N ratio, is set higher than the moving speed of the dummy image PG between Node A and Node B and the moving speed of the dummy image between Node C and Node D. In this manner, it becomes possible for the user to grasp whether a link is a high-speed data transmission link or not if the moving speed of dummy images is changed.

The network management apparatus 20 displays links using dummy images to allow easily identifying the difference in the data transmission path and the link quality between nodes. However, the network management apparatus 20 may display links using a display other than dummy images in order to easily identify the difference in the data transmission path and the link quality between nodes. For example, the network management apparatus 20 may dispose an arrow from a node of a data transmission source to a node of a destination so as to indicate a data transmission path, and may allow easily identifying the difference in the link quality by changing an attribute of the arrow.

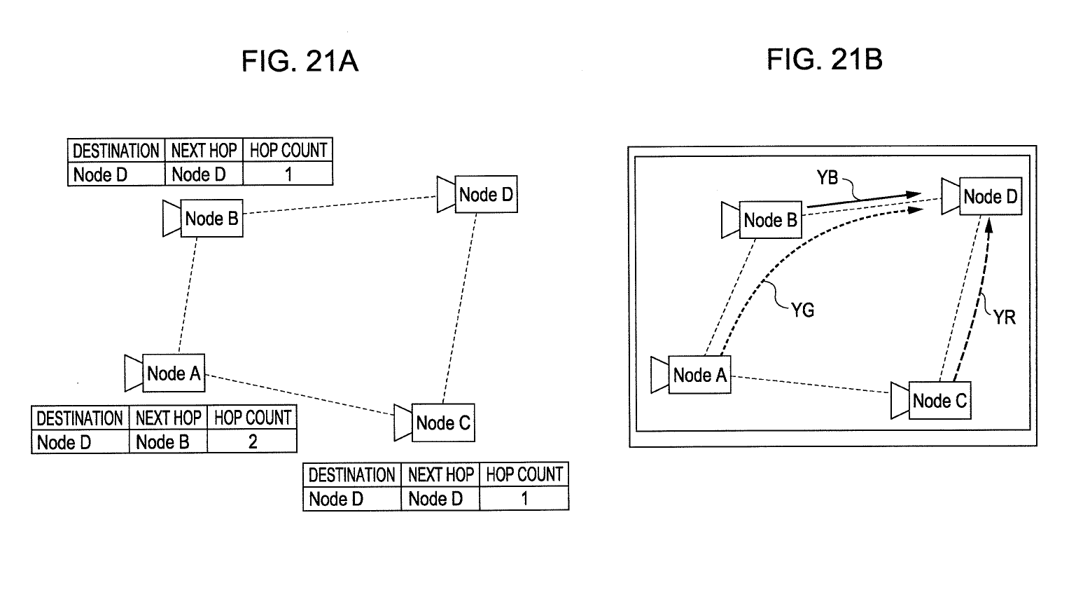

FIG. 21 illustrates the case of displaying a path using an arrow. In this regard, FIG. 21 shows Node A, Node B, Node C, and Node D. FIG. 21A shows a part of the routing table of Node A, Node B, and Node C. FIG. 21B shows a network configuration diagram displayed by the network management apparatus 20.

Here, the routing table of Node A indicates when the destination of Node D, the adjacent node is Node B. Also, the routing table of Node B indicates when the destination of Node D, the adjacent node is Node D. And the routing table of Node C indicates when the destination of Node D, the adjacent node is Node D.

In this case, as shown in FIG. 21B, the network management apparatus 20 displays an arrow by disposing a segment with a transmission-source node side as a start point and with a destination node side as an end point, and providing the end point of the segment with an arrow head indicating a data transmission direction. It becomes possible for the user to easily grasp a data transmission path by disposing such an arrow. In this regard, if a start point and an end point of a segment are only specified, it is difficult to determine a node which is performing data relay. For example, if an arrow display is disposed between Node A and Node D, it becomes difficult to determine that Node B is relaying. Accordingly, the network management apparatus 20 disposes an arrow so that a segment goes through Node B, which is performing data relay.

Also, an arrow may have different color for each data transmission path. For example, in the network configuration diagram, the network management apparatus 20 allows a link, which is used for transmitting data from Node A to Node D through Node B, to be identified by a green arrow YG. Also, the network management apparatus 20 allows a link, which is used for transmitting data from Node B to Node D, to be identified by a blue arrow YB. Further, the network management apparatus 20 allows a link, which is used for transmitting data from Node C to Node D, to be identified by a red arrow YR.

In this manner, the network management apparatus 20 allows a data link from a transmission source to a destination using a different color arrow for each data transmission path. Thus, it is possible for the user to easily grasp a transmission path for each data by what color arrow is disposed on which position.

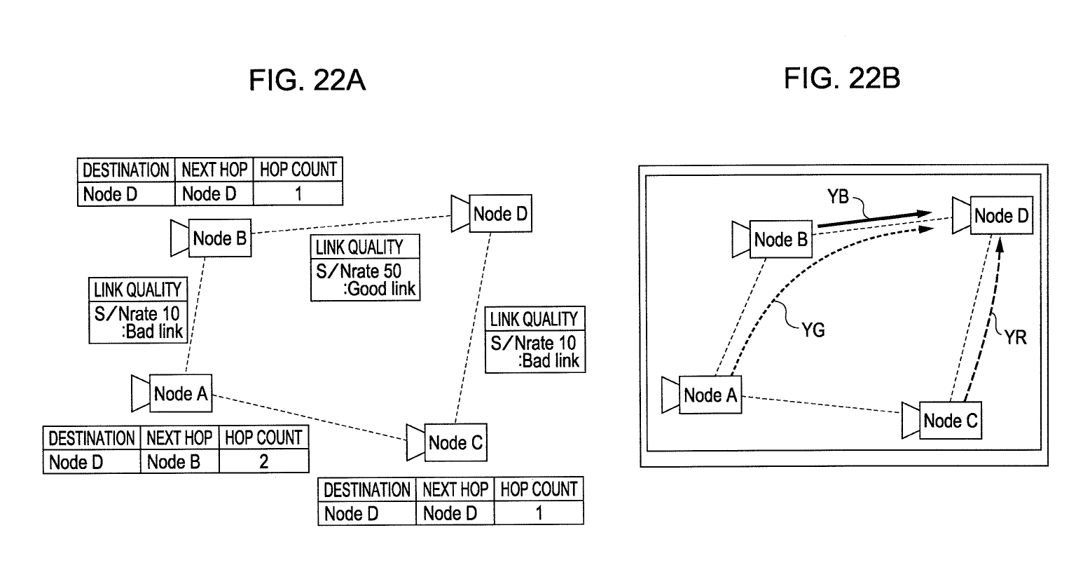

FIG. 22 illustrates the case of changing an attribute of an arrow display depending on a link quality. In this regard, FIG. 22 shows Node A, Node B, Node C, and Node D. Also, FIG. 22A shows a part of the routing table of Node A, Node B, and Node C, and link qualities, for example the S/N ratio. FIG. 22B shows a network configuration diagram displayed by the network management apparatus 20.

Here, the routing table of Node A indicates when the destination of Node D, the adjacent node is Node B. Also, the routing table of Node B indicates when the destination of Node D, the adjacent node is Node D. And the routing table of Node C indicates when the destination of Node D, the adjacent node is Node D. Also, the S/N ratio of the link between Node A and Node D is “10”, the S/N ratio of the link between Node B and Node D is “50”, and the S/N ratio of the link between Node C and Node D is “10”.

In this case, the network management apparatus 20 changes a width of an arrow segment in accordance with the S/N ratio. That is to say, it is possible for a link having a high S/N ratio to transmit more data per unit time compared to a link having a low S/N ratio, thus the network management apparatus 20 gives a wider arrow segment to a link having a high S/N ratio, and gives a narrower arrow segment to a link having a low S/N ratio because a larger amount of data can be transmitted per unit time compared to a link having a low S/N ratio. For example, as shown in FIG. 22B, the width of an arrow segment YB used for data transmission from Node B to Node D, which has a high S/N ratio, is set wider than an arrow segment YG used for data transmission from Node C to Node D through Node B, which has a low S/N ratio, and an arrow segment YR used for data transmission from Node C and Node D, which has a low S/N ratio. In this manner, it becomes possible for the user to grasp whether a link can transmit a large amount of data per unit time by changing the width of an arrow segment.

In this regard, in the case of changing an attribute of a display, when the link quality information indicates a plurality of piece of information, if each piece of information and a display attribute are related, it is possible to easily determine which piece of information among the link quality is changed in accordance with which attribute is changed.

Also, the above-described link quality information and a relationship between link quality information and attributes to be changed are examples, and are not limited to the description of the above-described embodiments.

The present application contains subject matter related to that disclosed in Japanese Priority Patent Application JP 2008-103049 filed in the Japan Patent Office on Apr. 11, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A network management apparatus comprising:
an information acquisition section obtaining path information and link quality information from a plurality of wireless terminals operating in an ad hoc mode; and
a display-information generation section generating a network configuration diagram showing a link state between the wireless terminals from the obtained path information, and changing an attribute of a display showing an established link in accordance with the link quality information.

2. The network management apparatus according to claim 1,
wherein the display-information generation section shows the established link by a line, and changes an attribute of the line in accordance with the link quality information.

3. The network management apparatus according to claim 2,
wherein the display-information generation section changes at least one of a type of line, color of line, and a width of line in accordance with the link quality information.

4. The network management apparatus according to claim 3, further comprising a user interface section generating an operation signal in accordance with a user's operation,
wherein when the display-information generation section determines that the user has selected the established link on the basis of the operation signal, the display-information generation section displays link quality information of the selected link on a network configuration diagram.

5. The network management apparatus according to claim 2,
wherein the display-information generation section shows a path whose link is established from a wireless terminal of a transmission source to a wireless terminal of a destination by an arrow.

6. The network management apparatus according to claim 1,
wherein the display-information generation section disposes a dummy image simulating a data unit between wireless terminals a link therebetween is established, moves the dummy image from the wireless terminal of the transmission source to the wireless terminal of the destination, and changes an attribute of the dummy image in accordance with the link quality information.

7. The network management apparatus according to claim 6,
wherein the display-information generation section changes at least one of color, a number, a moving velocity, and a shape of the dummy image in accordance with the link quality information.

8. The network management apparatus according to claim 7,
wherein the display-information generation section changes an attribute of the dummy image for each path from the wireless terminal of the transmission source to the wireless terminal of the destination.

9. A method of managing network, comprising the steps of:
obtaining path information and link quality information from a plurality of wireless terminals operating in an ad hoc mode; and
generating a network configuration diagram showing a link state between the wireless terminals from the obtained path information, and changing an attribute of a display showing an established link in accordance with the link quality information.

10. A monitoring system comprising:
an imaging apparatus including a function of wireless communication in an ad hoc mode; and
a monitoring apparatus displaying an image on the basis of image data obtained from the imaging apparatus,
wherein the monitoring apparatus includes
an information acquisition section obtaining path information, link quality information, and captured image information from the imaging apparatus, and
a display-information generation section generating a network configuration diagram showing a link state between the wireless terminals from the obtained path information, and changing an attribute of a display showing an established link in accordance with the link quality information.
